(19) United States
(12) Patent Application Publication
(10) Pub. No.: US 2022/0363183 A1
(43) Pub. Date: Nov. 17, 2022

(54) VIBRATOR AND REMOTE CONTROL THEREFOR

(71) Applicant: MARTIN ENGINEERING MICHIGAN, Marine City, MI (US)

(72) Inventors: Michael Holland, Marine City, MI (US); Michael Lindbeck, Marine City, MI (US)

(21) Appl. No.: 17/317,513

(22) Filed: May 11, 2021

(51) Int. Cl. B60P 1/58; G08C 17/02; B60P 1/04

(52) U.S. Cl. CPC B60P 1/58; G08C 17/02; B60P 1/04

(57) ABSTRACT

According to an aspect of this disclosure, a remote vibrator system includes a vibrator mounted to a container and a controller comprising a communication module. The remote vibrator system is configured such that the vibrator and the controller are operatively connected to a power source. The remote vibrator system also includes at least one remote control unit for controlling operation of the vibrator via wireless communication with the controller.

### TECHNICAL FIELD

The present subject matter relates to industrial vibrators, and more particularly, to vibrators for truck beds and/or other industrial, construction, and/or agricultural equipment.

### BACKGROUND

Truck bed vibrators attach to truck beds to cause vibration for complete filling or emptying of the truck bed. Truck bed vibrators are often associated with dump trucks or mixers but are suitable for deployment on other vehicles (e.g., grain transport, waste disposal, etc.). Conventionally, such vibrators operate from 12V or 24V power sources. Often times, a vibrator is mounted to the truck bed and wired to both the truck battery and a control switch/panel disposed somewhere on the truck (e.g., within the cab, on the side of the truck, etc.). Therefore, a system and method for installing and wirelessly controlling a vibrator on a truck bed or on another suitable equipment location represents an improvement in the art.

The description provided in the background section should not be assumed to be prior art merely because it is mentioned in or associated with the background section. The background section may include information that describes one or more aspects of the subject technology.

### SUMMARY

According to an aspect of this disclosure, a remote vibrator system includes a vibrator mounted to a container and a controller comprising a communication module. The remote vibrator system is configured such that the vibrator and the controller are operatively connected to a power source. The remote vibrator system also includes at least one remote control unit for controlling operation of the vibrator via wireless communication with the controller.

The remote vibrator system of this aspect may be further configured such that the at least one remote control unit is operatively connected to the power source.

The remote vibrator system of this aspect may be further configured such that the at least one remote control unit comprises at least one additional power source.

The remote vibrator system of this aspect may be further configured such that the container is associated with a vehicle having a vehicle cabin, and the power source is associated with the vehicle.

The remote vibrator system of this aspect may be further configured such that the controller is electrically connected to the power source without penetrating the vehicle cabin.

The remote vibrator system of this aspect may be further configured such that the at least one remote control unit is operable inside and outside the vehicle cabin.

The remote vibrator system of this aspect may be further configured such that the controller is electrically connected to the vibrator, and the at least one remote control unit commands the controller to supply electrical power to the vibrator in response to a button push.

The remote vibrator system of this aspect may be further configured such that the at least one remote control unit communicates with the controller by a wireless communications protocol.

The remote vibrator system of this aspect may be further configured such that the wireless communications protocol comprises one of radio frequency (RF), Zigbee, Bluetooth, Wi-Fi, and near field communications.

According to another aspect of the present disclosure, a method of remotely controlling a container vibrator includes the steps of mounting a vibrator to a container, such that the container is associated with a vehicle having a vehicle cabin, operatively connecting the vibrator to a wireless controller and a power source disposed outside of the vehicle cabin, and communicatively coupling the vibrator with a remote control device via the wireless controller. The method of remotely controlling a container vibrator in accordance with this aspect may further be performed such that the communicative coupling implements a wireless communication protocol. Also, the method of remotely controlling a container vibrator may include operating the remote control device to activate and deactivate the vibrator.

The method of remotely controlling a container vibrator in accordance with this aspect may further be performed such that the remote control device is operated from within the vehicle cabin.

The method of remotely controlling a container vibrator in accordance with this aspect may further be performed such that the remote control device is operated from a position remote from the vehicle, the vibrator, and the container.

The method of remotely controlling a container vibrator in accordance with this aspect may further be performed such that the remote control device is operated without a wired connection to the vibrator extending into the vehicle cabin.

The method of remotely controlling a container vibrator in accordance with this aspect may further be performed such that the remote control device is operated from a position remote from the vehicle, the vibrator, and the container.

The method of remotely controlling a container vibrator in accordance with this aspect may further be performed such that the remote control device is a mobile device.

According to yet another aspect of the present disclosure, a transportation system includes a vehicle and a storage container, a vibrator disposed proximal the storage container, a wireless controller in electrical communication with the vibrator, and a remote control unit communicatively coupled to the wireless controller. The transportation system may further be configured such that the remote control unit communicates with the wireless controller via a wireless communication protocol to control electrical power supplied to the vibrator.

The transportation system may further be configured such that the wireless controller is disposed within a waterproof housing.

The transportation system may further be configured such that the wireless controller supplies power to the vibrator at in response to a command transmitted by the remote control unit.

The transportation system may further be configured such that the storage container comprises an agricultural trailer.

The transportation system may further be configured such that the vehicle is a tractor.

Other aspects and advantages of the present invention will become apparent upon consideration of the following detailed description and the attached drawings wherein like numerals designate like structures throughout the specification.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 depicts an exemplary wireless vibrator arranged on a truck bed;

FIG. 2 illustrates an exemplary wireless controller system for an exemplary remote vibrator and remote vibrator control system and method described in the present disclosure;

FIG. 3A is a plan view of a wireless controller of the wireless controller system, shown in FIG. 2, with a portion of an exterior housing removed to show a control circuit of the wireless controller;

FIG. 3B is an isometric view of a portion of the control circuit of the wireless controller in FIG. 3A;

FIG. 4 is a schematic diagram showing electrical components of the control circuit of the wireless controller in FIGS. 3A and 3B;

FIG. 5 is a schematic diagram showing electrical connections that deliver power between an exemplary power source, the wireless controller, and the remote vibrator;

FIG. 6 illustrates an exemplary remote vibrator for an exemplary remote vibrator system, having been installed according to an exemplary remote vibrator installation method;

FIG. 7 illustrates an exemplary wireless controller for use with the remote vibrator shown in FIG. 6; and

FIGS. 8-10 illustrate exemplary agricultural equipment to which the remote vibrator system may be applied.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

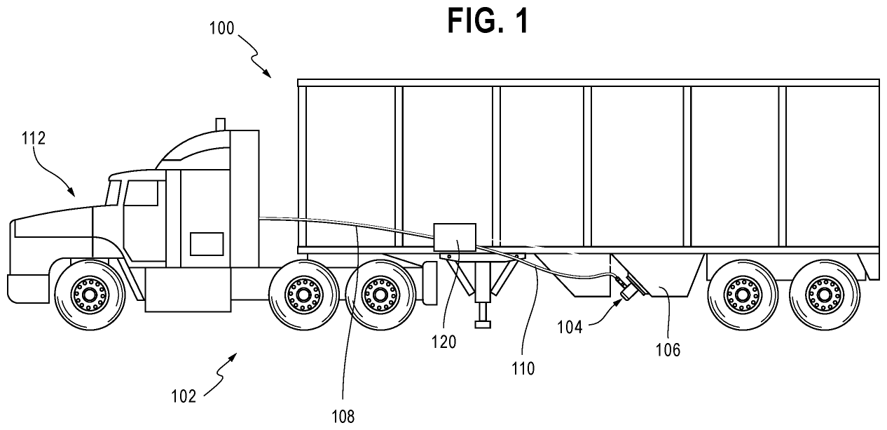

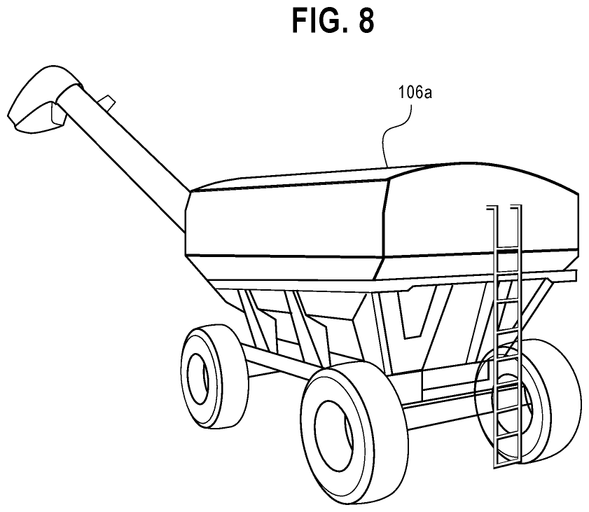

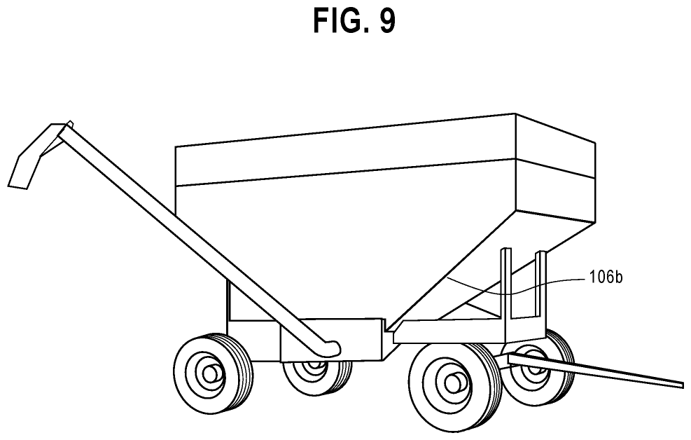

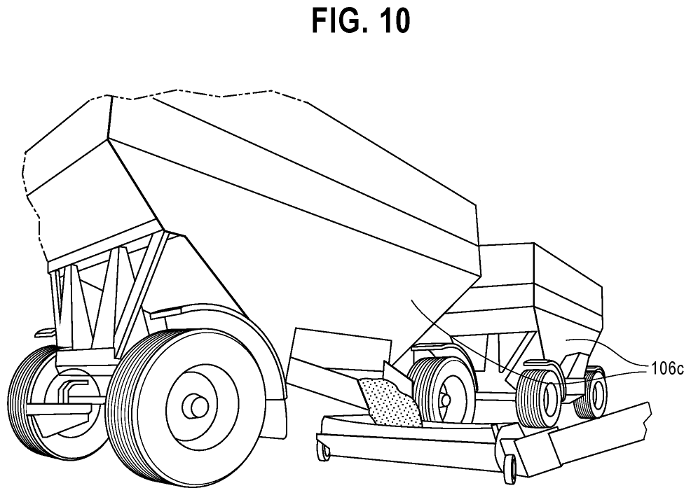

Generally, the present disclosure details, with reference to FIGS. 1-10, a remote vibrator system 100 comprising a wireless controller system 102 and a remote vibrator 104. In FIG. 1, an exemplary container, shown as a truck bed 106, suitable for application of the remote vibrator system 100 is shown with the remote vibrator 104 positioned on an underside of the truck bed 106. For ease of description, the described system and installation method may refer to the truck bed 106 as an exemplary configuration; however, it is contemplated and one of skill will appreciate that the described system and method may be applicable to numerous types of storage and transportation containers, such as but not limited to agricultural equipment/trailers (see FIGS. 8-10, showing alternative containers 106a, 106b, 106c), industrial equipment, dump trucks, garbage trucks, construction equipment, concrete mixing transport trucks and/or trailers, grain/feed/seed shipping containers, shipping containers for other natural resources such as earth, ore, gravel, coal, etc., intermodal shipping containers, etc. The system and method may be further applicable to containers that are permanently, semi-permanently, or detachable from a truck or tractor (e.g., permanently affixed concrete mixers as compared with modular intermodal shipping containers). Still further, the system and method may be further applicable to containers associated with other transportation methods including, but not limited to, rail transport, air transport, maritime transport, and/or fluvial transport.

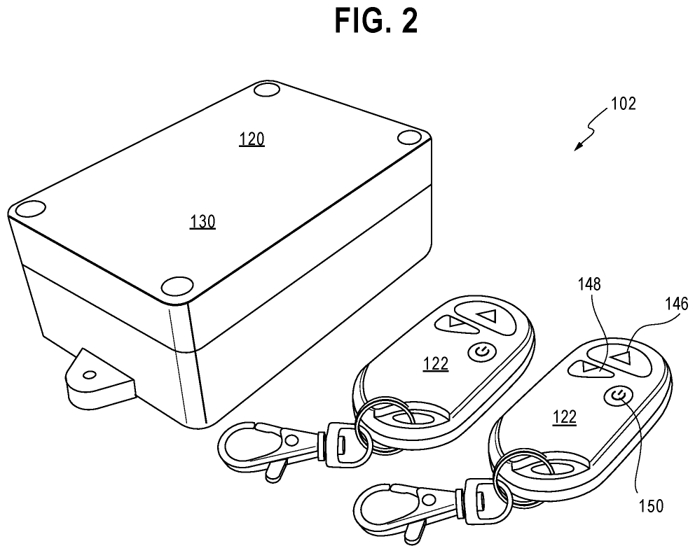

As shown in FIG. 1, the remote vibrator system 100 is configured for use on the truck bed 106. Electrical connections, shown as insulated wires 108, 110, operatively connect the remote vibrator 104 with a power source 112 and a wireless controller 120 of the wireless controller system 102. Referring to FIG. 2, the wireless controller system 102 comprises the wireless controller 120 and one or more remote control units or devices 122. The remote control unit(s) 122 allow for a user of the remote vibrator system 100 to remotely operate the remote vibrator 104, such as from within a truck or tractor cabin. Alternatively, the remote control units 122 may operate the remote vibrator 104 from some point exterior to the truck cabin and remote from the container, such as a point of safety and/or a location wherefrom the truck bed 106 and the contents thereof are visible. Operation of the remote vibrator 104 may cause some wear and tear on the container 106 and/or itself. Therefore, activation of the remote vibrator 104 only when needed, only for as long as needed, and/or prompt deactivation when the container 106 has been filled/emptied, may improve operational efficiency of the remote vibrator 104 and/or the container 106.

In conventional vibrator configurations a control box with an on/off switch is mounted within a truck/tractor cabin, outside a truck/tractor cabin, or elsewhere along a truck bed or agricultural trailer. When the on/off switch is mounted within a truck cabin, the cabin must be penetrated to facilitate installation so that a conventional wired connection is completed between the on/off switch and a hardwire-controlled vibrator. Alternatively, conventional vibrator controls are mounted outside of a truck cabin or along a truck bed (often times within close proximity to the wired vibrator itself). In contrast, the presently described remote vibrator system 100 provides remote operation, via a wireless connection between the one or more remote control units 122 and the wireless controller 120 such that the remote vibrator 104 may be operated without exiting a truck cabin, and installation of the remote vibrator system 100 may be carried out without penetrating the truck cabin.

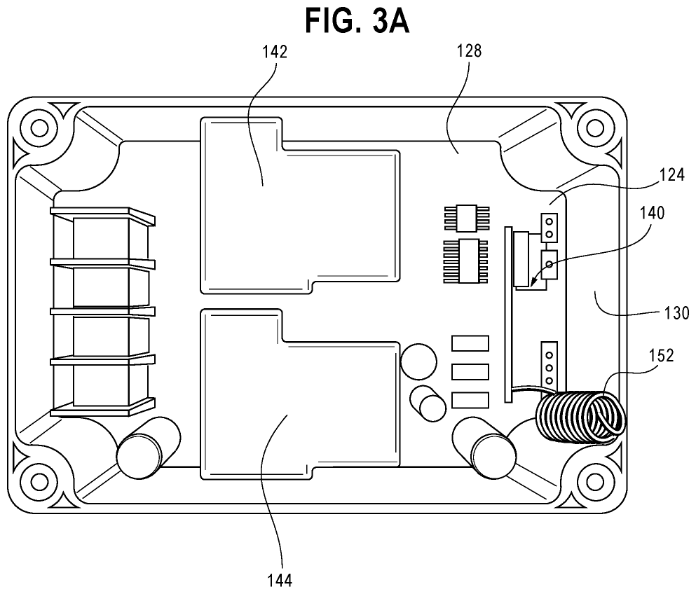

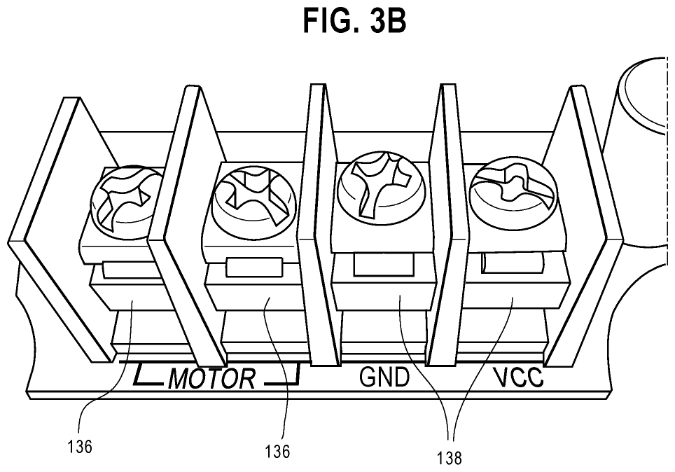

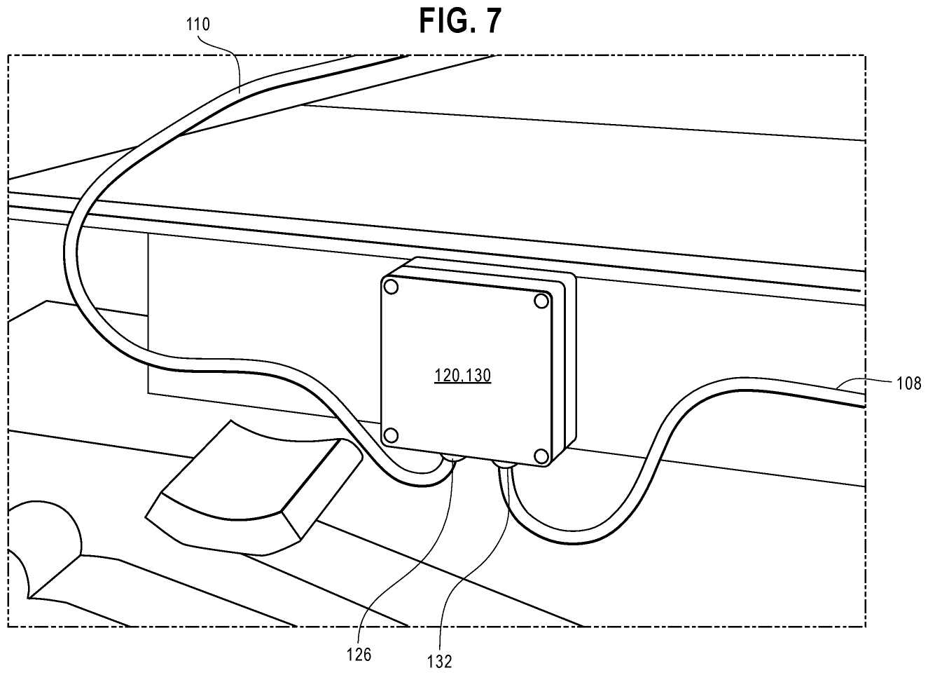

Referring to FIGS. 3A and 3B, a control circuit 124 of the wireless controller 120 is shown. Electrical components of the wireless controller 120 are mounted on a printed circuit board 128 and configured within a housing 130 (see also FIG. 2). The housing 130 has a first access point 126 (see also FIG. 7) through which the insulated wires 110 are connected to the remote vibrator 104. The wires 110 connecting the wireless controller 120 and the remote vibrator 104 facilitate transmission of control signals between the wireless controller 120 and the remote vibrator 104. Additionally, the housing 130 has a second access point 132 (again, see also FIG. 7) through which the insulated wires 108 are connected to the power source 112 to provide power to the wireless controller 120 and the remote vibrator 104 via the wireless controller 120 in accordance with particular commands. FIG. 3B shows four terminals for electrically coupling the wireless controller 120 and the remote vibrator 104. The four terminals include two control/power terminals 136 for operation of the remote vibrator 104, and ground and positive terminals 138 for introduction of electrical power to the wireless controller 120.

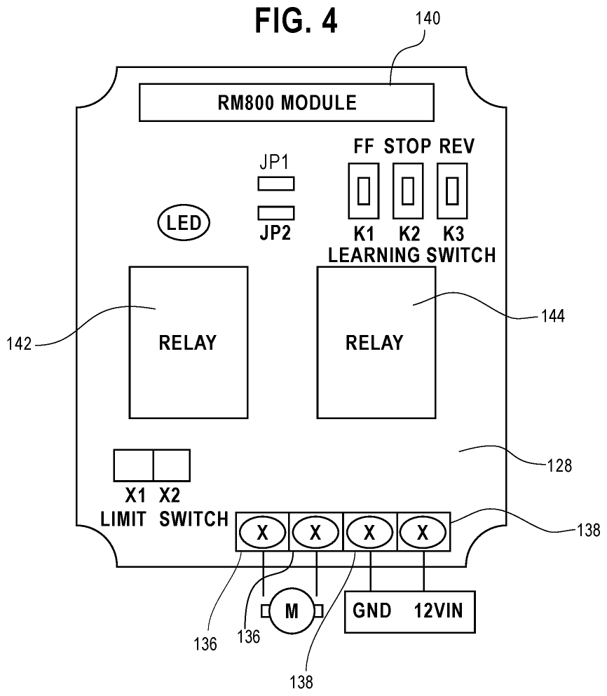

A schematic of the control circuit 124 is further detailed in FIG. 4. A control and communications module 140, which includes a wireless receiver or transceiver, connects the control circuit 124 with the one or more remote control units 122. The control/communications module 140 further operates first and second relay switches 142, 144 to operate the remote vibrator 104. In an exemplary embodiment, the one or more remote control units 122 comprise first, second, and third buttons 146, 148, 150 that, respectively, drive the remote vibrator 104 in a first direction (forward), drive the remote vibrator 104 in a second direction (reverse), and stop operation of the remote vibrator 104. The one or more remote control units 122 may be programmed to establish a wireless connection with the control module 140. The control module 140 may be operatively connected to one or more antennas 152 (see FIG. 3A) to facilitate the wireless connection to the one or more remote control units 122. One or more overcurrent protection devices may be incorporated into the control circuit 124 and likewise housed within the housing 130 of the wireless controller 120.

In the example of FIGS. 3A-4, the control module 140 includes a radio frequency (RF) transceiver or receiver that pairs with the one or more remote control units 122, which are RF transceivers or transmitters. Exemplary embodiments may include, alternatively or additionally, other suitable wireless communications modules that implement other suitable communications protocols such as Zigbee®, Bluetooth®, Wi-Fi®, near field communications (NFC), etc. Similarly, the one or more remote control units 122 are RF transceivers or transmitters; however, the remote control units 122 may be an RF keychain fob, an RF transceiver having a different form factor, and/or a device compatible with another of the alternative communications protocols noted hereinabove. For example, a Bluetooth® transceiver may be a suitable remote control unit to pair with a Bluetooth® beacon housed within the wireless controller 120. In further examples, the wireless controller 120 may comprise one or more control modules 140 implementing one or more communications protocols compatible with a mobile device (e.g., a smartphone, smart watch, tablet, infotainment system, headset, etc.). In an exemplary embodiment, a user may pair a Bluetooth®-capable smartphone with the wireless controller 120 and interact with the remote vibrator system 100 via a mobile application. In another embodiment, a user may pair an in-cabin infotainment system with Bluetooth® connectivity to the wireless controller 120, thereby allowing operation of the remote vibrator system 100 from within a truck cabin. Still further, a Bluetooth® capable device that responds to voice commands may be utilized as a remote control unit suitable for the wireless controller system 102. A suitable device utilized as the remote control unit may be permanently associated with the wireless controller 120 or may be interchangeable, e.g., an operator may bring their own device for pairing and use with the wireless controller 120.

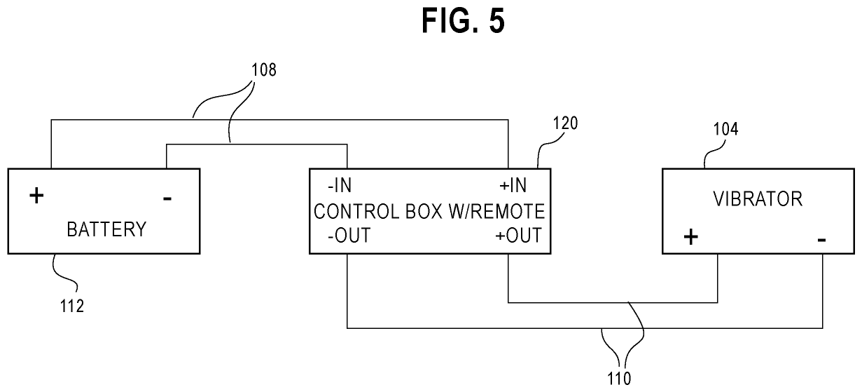

Referring now to the example of FIG. 5, electrical connections between the remote vibrator 104, the power source 112, and the wireless controller 120. In this example, insulated wires 108 connect a battery to the wireless controller 120 to provide the wireless controller 120 with electrical power. As noted above, the control circuit 124 of the wireless controller 120 receives wireless commands from the one or more remote control units 122 and translates said commands into electrical power for the remote vibrator 104. As a result, electrical power is supplied to the remote vibrator 104 from the control circuit 124 via insulated wires 110 in response to a command to turn on the remote vibrator 104. Similarly, the supply of electrical power to the remote vibrator 104 ceases in response to the control circuit 124 receiving a command to turn off the remote vibrator 104. Alternatively, the control circuit 124 may not supply electrical power to the remote vibrator 104 by default; and, instead, only supply electrical power to the remote vibrator 104 in response to a continuous button hold performed by a user with the one or more remote control units 122. In the further alternative, provision of electrical power to the remote vibrator 104 may be controlled by a timer or counter (e.g., in response to actuation of the first button 146, the remote vibrator 104 may be supplied with electrical power for 30 seconds before turning off).

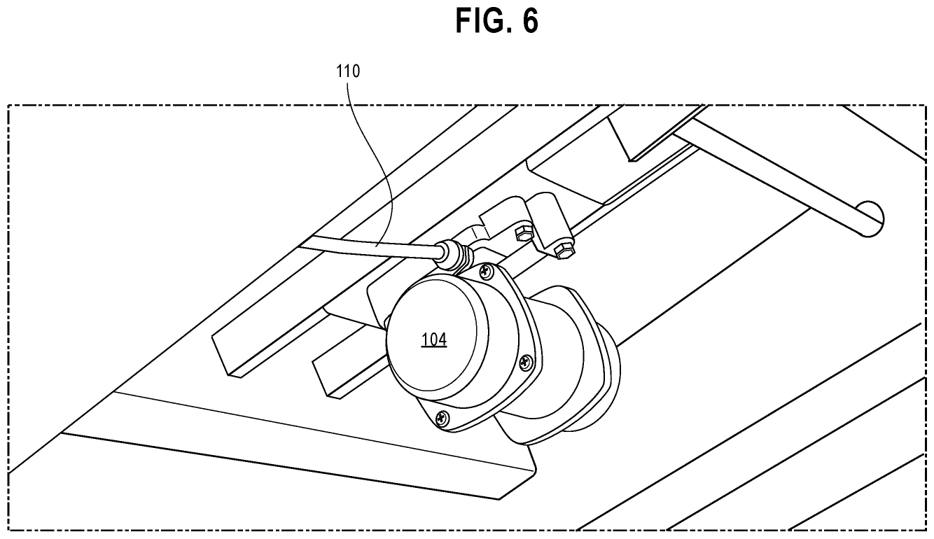

FIGS. 6 and 7 illustrate the remote vibrator 104 and the wireless controller 120 in situ mounted to the underside of a truck bed. In FIG. 6, the insulated wires 108 operatively connect the wireless controller 120 to the power source 112. Also, the insulated wires 110 operatively connect the wireless controller 120 to the remote vibrator 104 to transmit control commands and electrical power thereto. In alternative embodiments, the insulated wires may be combined such that the housing 130 of the wireless controller 120 comprises only one access point. In such an example, electrical power may be supplied separately to the remote vibrator 104 such that the wireless controller 120 supplies control signals to the remote vibrator 104 without supplying electrical power necessary for operation of the remote vibrator 104. Further, in such an embodiment, one or more alternative power sources may be disposed proximal or within the housing 130 of the wireless controller 120, e.g., a battery within the housing 130 to facilitate wireless communications and generation of control commands for transmission to the remote vibrator 104. In other contemplated embodiments, the remote vibrator 104 and the wireless controller 120 may be integrated into a single component with a single housing. In such an exemplary embodiment, the control circuit 124 may be integrated into a housing of the remote vibrator 104 such that electrical connections from the control circuit 124 that provide commands to the remote vibrator 104 are disposed within the housing. Further, in this example, the housing of the combined remote vibrator and wireless controller may have a single access point facilitating connection to the power source 112.

The remote vibrator 104 and the wireless controller system 102 combine to improve control of the remote vibrator 104 by making control simpler and requiring fewer hardware component and shorter hardware installation. Specifically, the presently disclosed remote vibrator system 100 eliminates the need for an entire circuit and housing structure of the conventional control mechanism for a truck bed vibrator. By eliminating a controls box mounted within a truck/tractor cabin, installation time is significantly reduced because installation of the presently described remote vibrator system 100 does not require penetration of the truck/tractor cabin. Instead, power may be sourced from a truck or tractor battery accessible via an engine hood or an electrical connector commonly available for trailer hook-up. When a conventional truck bed vibrator hardwired controller is installed within a truck cabin, the penetration of the cabin, mounting of the hardwired controller, and provision of power to the controller through the truck cabin are all truck cabin specific (e.g., some truck cabins may be penetrated at one point but not at another, mounting requires differing brackets based on truck cabin mounting location, etc.). Therefore, the presently disclosed remotely controlled vibrator system 100 decreases the cost, time, and disruption caused by outfitting or retrofitting and container and vehicle cabin with a vibration system. While the remote vibrator system 100 significantly reduces the complexity of hardware installation as compared to a conventional truck bed vibrator, the system 100 also improves control by providing for remote control from within a vehicle cabin or remote from the container 106 and vehicle cabin, and/or a combination of both (e.g., a user starts vibration from within the cabin, exits the cabin, and deactivates the remote vibrator 104 upon observation of the vibrated container 106).

The embodiment(s) described above may be combined in full or in part, with any alternative embodiment(s) described.

### INDUSTRIAL APPLICABILITY

The disclosed systems and methods can be implemented with an electronics system, using, for example, software, hardware (e.g., passive and/or active electronic components), and/or a combination of both, either with a dedicated microcontroller, integrated into another entity (e.g., communications device), or distributed across multiple entities (e.g., partially in the remote control unit and partially within the wireless controller). According to one aspect of the present disclosure, the disclosed system can be implemented using a number of active and/or passive electronic components in response to a processor executing one or more sequences of one or more instructions contained in memory. Such instructions may be read into memory from another machine-readable medium, such as a data storage device. Execution of the sequences of instructions contained in main memory causes the processor to implement the initiation and communication features described herein. One or more processors in a multi-processing arrangement may also be employed to execute the sequences of instructions contained in memory. In alternative implementations, hard-wired circuitry may be used in place of or in combination with software instructions to implement various implementations of the present disclosure. Thus, implementations of the present disclosure are not limited to any specific combination of hardware circuitry and software (e.g., different remote control units, wireless controllers, and remote vibrators may be used and/or combined).

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only and should not be taken as limiting the scope of the disclosure. In addition, apparatus aspects may be applied to method aspects, and vice versa. Furthermore, any, some and/or all features in one aspect can be applied to any, some and/or all features in any other aspect, in any appropriate combination. It should also be appreciated that particular combinations of the various features described in and defined by any aspects of the present disclosure may be implemented and/or supplied and/or used independently.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode presently known for carrying out the disclosure. It should be understood that the illustrated embodiments are exemplary only, and should not be taken as limiting the scope of the disclosure.

What is claimed is:

1. A remote vibrator system, comprising:
a vibrator mounted to a container;
a controller comprising a communication module,
wherein the vibrator and the controller are operatively connected to a power source;
at least one remote control unit for controlling operation of the vibrator via wireless communication with the controller.

2. The remote vibrator system of claim 1, wherein the at least one remote control unit is operatively connected to the power source.

3. The remote vibrator system of claim 1, wherein the at least one remote control unit comprises at least one additional power source.

4. The remote vibrator system of claim 1, wherein the container is associated with a vehicle having a vehicle cabin, and wherein the power source is associated with the vehicle.

5. The remote vibrator system of claim 4, wherein the controller is electrically connected to the power source without penetrating the vehicle cabin.

6. The remote vibrator system of claim 5, wherein the at least one remote control unit is operable inside and outside the vehicle cabin.

7. The remote vibrator system of claim 5, wherein the controller is electrically connected to the vibrator, and the at least one remote control unit commands the controller to supply electrical power to the vibrator in response to a button push.

8. The remote vibrator system of claim 5, wherein the at least one remote control unit communicates with the controller by a wireless communications protocol.

9. The remote vibrator system of claim 8, wherein the wireless communications protocol comprises one of radio frequency (RF), Zigbee, Bluetooth, Wi-Fi, and near field communications.

10. A method of remotely controlling a container vibrator, comprising:
mounting a vibrator to a container,
wherein the container is associated with a vehicle having a vehicle cabin;
operatively connecting the vibrator to a wireless controller and a power source disposed outside of the vehicle cabin;
communicatively coupling the vibrator with a remote control device via the wireless controller,
wherein the communicative coupling implements a wireless communication protocol;
operating the remote control device to activate and deactivate the vibrator.

11. The method of remotely controlling a container vibrator of claim 10, wherein the remote control device is operated from within the vehicle cabin.

12. The method of remotely controlling a container vibrator of claim 11, wherein the remote control device is operated from a position remote from the vehicle, the vibrator, and the container.

13. The method of remotely controlling a container vibrator of claim 11, wherein the remote control device is operated without a wired connection to the vibrator extending into the vehicle cabin.

14. The method of remotely controlling a container vibrator of claim 10, wherein the remote control device is operated from a position remote from the vehicle, the vibrator, and the container.

15. The method of remotely controlling a container vibrator of claim 10, wherein the remote control device is a mobile device.

16. A transportation system, comprising:
a vehicle and a storage container;
a vibrator disposed proximal the storage container;
a wireless controller in electrical communication with the vibrator;
a remote control unit communicatively coupled to the wireless controller,
wherein the remote control unit communicates with the wireless controller via a wireless communication protocol to control electrical power supplied to the vibrator.

17. The transportation system of claim 16, wherein the wireless controller is disposed within a waterproof housing.

18. The transportation system of claim 17, wherein the wireless controller supplies power to the vibrator in response to a command transmitted by the remote control unit.

19. The transportation system of claim 18, wherein the storage container comprises an agricultural trailer.

20. The transportation system of claim 19, wherein the vehicle is a tractor.
